(19) United States
(12) Patent Application Publication
(10) Pub. No.: US 2010/0038817 A1
(43) Pub. Date: Feb. 18, 2010

(54) Device, production and method for thermoplastic polymers containing coarse-scale and/or nanoscale, coated, de-agglomerated magnesium hydroxide particles

(76) Inventors: David Christopher Glende, Bovenden (DE); Sascha Ahlert, Dortmund (DE); Joerg-Heino Sachse, Aachen (DE); Ingo Stahl, Vellmar (DE); Willi Vogel, Kassel (DE); Jens Hohmann, Kassel (DE); Rainer Schmidt, Kassel (DE); Andrzej Bledzki, Ahnatal (DE)

Correspondence Address: COLLARD & ROE, P.C., 1077 NORTHERN BOULEVARD, ROSLYN, NY, 11576, US

(21) Appl. No.: 12/460,957

(22) Filed: Jul. 27, 2009

(30) Foreign Application Priority Data
Aug. 12, 2008 (DE) 10 2008 038 667.7

(51) Int. Cl. B29C 47/36; C08K 3/22; B28C 5/48

(52) U.S. Cl. 264/211; 523/200; 366/108; 425/113

(57) ABSTRACT

A method and device for the production of thermoplastics containing coarse-scale and/or nanoscale, coated, de-agglomerated magnesium hydroxide particles that are supplied to the thermoplastic in the form of a dispersion or suspension in an aqueous or organic solvent, and mixed with the themoplastic. The thermoplastics filled with magnesium hydroxide particles demonstrate improved mechanical properties, particularly an improved modulus of elasticity and low brittleness.

### CROSS REFERENCE TO RELATED APPLICATIONS

Applicants claim priority under 35 U.S.C. §119 of German Application No. 10 2008 038 667.7 filed Aug. 12, 2008.

### BACKGROUND OF THE INVENTION

1. Field of the Invention

The present application relates to methods for the production of filled thermoplastics containing coarse-scale and/or nanoscale, coated magnesium hydroxide particles. The particles are supplied to the thermoplastic in the form of a suspension or dispersion, in an aqueous or organic solvent. Furthermore, the present application is directed at a device for the production of thermoplastics containing coarse-scale and/or nanoscale, coated magnesium hydroxide particles as fillers, in which the magnesium hydroxide particles are added to the thermoplastic in the form of a suspension or dispersion. Finally, the present application is directed at the thermoplastics themselves.

2. The Prior Art

It is generally known that fillers are introduced into plastics both for modifying their properties and for cost reduction. These fillers can be coarse-scale as well as nanoscale with regard to their particle size, and are usually introduced into the polymer as a dried powder.

Thermoplastic plastics that contain inorganic materials as fillers are generally known and can be found in countless everyday examples. These fillers are generally mixed into the polymer base material at a high percentage proportion, with the goal of imparting specific properties to it. Thus, for example, when using barium sulfate as a filler, the weight of the polymer can be greatly increased, because of the high intrinsic density of this material, and as a result, an improved sound-absorbing function is achieved, for example. Also, using this mineral, it is possible to achieve an X-ray absorbing function, which is of great interest in the field of medical technology, for example. Furthermore, the product costs can be reduced by the use of fillers in plastics, since the inorganic fillers generally have a lower price than the polymers used. Inorganic fillers, such as ground or precipitated calcium carbonate, talcum, or phyllosilicates, have a great influence on the mechanical properties of the polymer material. Most of the fillers that are used at high percentage proportions frequently result in a significant increase in the modulus of elasticity (e-modulus). However, this is generally connected with lower elongation to tear and impact values. This increased brittleness of the material is frequently problematic, but cannot be avoided.

Magnesium hydroxide is used as a functional filler, for example in the area of fire protection. It gives the polymer a flame-inhibiting property. This is due to the fact that magnesium hydroxide gives off its water of crystallization above 300° C., which cools the polymer in case of a fire, and furthermore forms a stable and protective oxide layer. In order to be able to achieve these flame-inhibiting properties, filler contents of at least 50 wt.-% in the polymers are required. With this filler content, it is possible to achieve the fire class V0 according to the flame protection test UL94 developed by Underwriters Laboratory, but the mechanical properties of the plastic clearly suffer from the high degree of inorganic filler. In this connection, increased brittleness of the plastic frequently occurs, connected with a low impact capacity and low elongation to tear values.

When filling thermoplastics, the method of choice is considered to be introduction of the filler in the form of finely ground powder, using an extruder. However, particularly in the case of thermoplastic materials and the use of nanoscale material, de-agglomeration of the nanoparticle filler resulting from the shear forces of the extruder roller(s) occurs only in part. In other words, the fillers, although they are referred to as nanoparticles, are actually present in the powder as coarse-scale agglomerates of the nanoparticles. These agglomerated nanoparticles in the micrometer range are not completely separated from one another by the shear forces that occur in the extruder, and therefore the polymer materials containing these nanoscale materials demonstrate a mechanical property profile that is the same as that of thermoplastics containing coarse-scale fillers.

International Application No. PCT/US02/17250 describes a method for the production of silica-based nanocomposites by means of extrusion in polymethyl methacrylate. In this document, the filler is functionalized with silanes, but agglomerated “fumed silica types” (Aerosil® from Degussa) are used, which are present as agglomerated powders. These agglomerates, which consist of nanoscale primary particles, are coated with silanes, but the individual nanoscale primary particles are not. They are not present in individually coated form.

International Application Publication No. WO 2002/081574 describes a coating of magnesium hydroxide powder in a Henschel mixer, with amino silanes, titanates, zirconates, and fatty acids, and subsequent introduction into polyamides. Here, however, only agglomerates are coated, not primary crystals, and the subsequent introduction into the polymers does not take place in de-agglomerated form.

In fact, until now, only agglomerated magnesium hydroxides, which consist either of coarse-scale or nanoscale primary particles, have been worked into thermoplastics. Even if nanoscale primary particles are used in this connection, these are still present in the thermoplastic as agglomerates in the micrometer range due to the drying process for obtaining the dried powders that are used, so that the mechanical properties of the filled polymer are similar to those of a plastic filled with coarse-scale magnesium hydroxide. The drying step brings about agglomeration of the nanoscale particles, which cannot be completely de-agglomerated even by the mechanical forces that occur during the mixing process, for example in an Ultraturrax or a dissolver, since these mechanical forces are not sufficient.

### SUMMARY OF THE INVENTION

It is therefore an object of the present invention to provide a method that allows an improvement in the mechanical properties of polymers after fillers have been worked into them. Another object of the present invention is to make available methods for the production of thermoplastics filled with fillers, particularly magnesium hydroxide particles.

Finally, it is another object of the present invention to make available devices suitable for implementing these methods for the introduction of fillers, particularly magnesium hydroxide particles, into thermoplastics.

In a first aspect, the present invention is directed to a method for the production of thermoplastics containing coarse-scale and/or nanoscale, coated and de-agglomerated magnesium hydroxide particles essentially in the form of their coated primary particles, comprising the following steps:

a) providing a thermoplastic;

b) providing coarse-scale and/or nanoscale, coated magnesium hydroxide particles as a suspension or dispersion in an aqueous or organic solvent;

c) supplying the coarse-scale and/or nanoscale, coated magnesium hydroxide particles to the thermoplastic in suspension or dispersion;

d) mixing the magnesium hydroxide particles with the heated, melted thermoplastic;

e) if necessary, removing the solvent of the suspension or dispersion from the mixture from step d).

The thermoplastics filled with magnesium hydroxide particles demonstrate improved mechanical properties, particularly an improved modulus of elasticity. In particular, the thermoplastics filled with nanoscale, coated magnesium hydroxide particles essentially in the form of the coated primary particles demonstrate superior mechanical properties both with regard to the modulus of elasticity and with regard to low brittleness.

The term “filled thermoplastics,” as it is being used here, relates to a thermoplastic that contains magnesium hydroxide particles. The term “nanoscale,” as it is being used here, relates to particles having an average diameter (d50) of ≦100 nm. Preferably, at least 70%, such as 80%, for example 90%, particularly 95%, such as 98% or 99% of the particles demonstrate a diameter of ≦100 nm.

The term “coarse-scale,” as it is being used here, relates to particles having an average diameter (d50) of >100 nm. Preferably, at least 70%, such as 80%, for example 90%, particularly 95%, such as 98% or 99% of the particles demonstrate a diameter of >100 nm.

The term “de-agglomerated,” as it is being used here, means that the secondary particles are not completely present as primary particles, but rather these secondary particles are present in clearly less agglomerated or aggregated form than after a drying step of non-coated primary or secondary particles. Because every primary particle is present in coated form, any de-agglomeration that might be necessary can be carried out more easily. In the present case, these loosely agglomerated (de-agglomerated) particles are broken down into the primary particles as the result of the mechanical forces, such as shear forces, that occur during mixing of the thermoplastic with the magnesium hydroxide particles, so that the magnesium hydroxide is present in the thermoplastic in the form of its primary particles, and homogeneously distributed, to the greatest possible extent.

Since the de-agglomerated and coated magnesium hydroxide particles are already introduced into the thermoplastic as a suspension or dispersion, de-agglomeration and separation of the primary particles in the thermoplastic—in contrast to the dried powder used in the state of the art—is no longer necessary. As a result, thermoplastics having homogeneously distributed fillers are obtained, and the disadvantages of the use of agglomerated fillers, such as brittleness of the material, are improved, and the modulus of elasticity is increased. According to the invention, a suspension or dispersion of the coarse-scale and/or nanoscale, coated, if necessary de-agglomerated magnesium hydroxide particles is brought into contact with the thermoplastic, and then mixed with the thermoplastic. In this connection, the thermoplastic can already be present in melted form.

The magnesium hydroxide particles that are present in the suspension or dispersion as coarse-scale and/or nanoscale magnesium hydroxide particles, have a complete coating of the individual primary particles. This complete coating of the primary particles is achieved using an “in situ” method, in which suitable additives are already added to the reaction mixture consisting of alkali hydroxide and magnesium salt solution during the precipitation reaction, which additives allow coating (coating) of the primary particles (as described, for example, in German Patent Application No. DE 10 2008 031 361.0, which has not yet been published).

In other words, the materials used as magnesium hydroxide particles are obtained by bringing a magnesium salt solution into contact with an alkali hydroxide solution, with the formation of a reaction mixture for the precipitation of coated magnesium hydroxide primary particles, whereby one of the additives A, B and/or C is contained in at least one of the magnesium salt solution or alkali hydroxide solution, or when one of the two solutions is brought into contact, at least one of the additives A, B and/or C that is present is simultaneously brought into contact with the reaction mixtures that result from the two solutions. The additives are a growth inhibitor A, a dispersant B and/or an aqueous fatty acid solution C, or mixtures of these.

In this way, the production of precoated magnesium hydroxide particles is possible, whereby each individual one of the magnesium hydroxide primary particles is completely coated, since a coating already forms on the surface during the precipitation process, due to the presence of the aforementioned additives. These coarse-scale and/or nanoscale, coated, de-agglomerated magnesium hydroxide particles are present in the form of a suspension or dispersion, and are brought into direct connection with the thermoplastic in this form (as described, for example, in German Patent Application No. DE 10 2008 031 361.0, which has not yet been published).

If necessary, a treatment by a bead mill or ultrasound can follow, as a de-agglomeration process. In the case of these methods, the particles are provided with an additional surface coating by the addition of suitable additives or additive mixtures. These de-agglomeration processes take place, in this connection, with different dispersants, depending on the solvent. When using an organic solvent, a dispersant D is used, while when using an aqueous solvent, a dispersant B is used, which can be identical with the dispersant B during the precipitation reaction.

The coarse-scale or nanoscale particles consisting of magnesium hydroxide that are formed during the de-agglomeration process by a bead mill or ultrasound are electrostatically and/or sterically stabilized by the addition of dispersant B (aqueous solvents) or dispersant D (organic solvents), and are thus protected against re-agglomeration. The polarity of the particles is also adapted by suitable dispersants B or dispersants D, respectively, to the subsequent polymer target matrix, and thus their subsequent working into the thermoplastic is facilitated. The coating also acts as a spacer, since the crystal surfaces of the coarse-scale and/or nanoscale particles cannot touch, and thus the nanoscale particles are prevented from growing together to form larger aggregates. Thus, the formation of solid aggregates is prevented. Also, the dispersants B or dispersants D that are added during the de-agglomeration steps can already carry functional groups that can subsequently bind the coarse-scale and/or nanoscale particles covalently to the polymer matrix, in order to allow a significant improvement in the mechanical properties of the polymer materials.

Because of the use of coated magnesium hydroxide particles, it is possible to introduce the particles into the thermoplastic, and to separate the particles during mixing, in order to achieve a homogeneous distribution of the coated primary particles in the thermoplastic. In this connection, the magnesium hydroxide particles are passed to the thermoplastic as a coarse-scale and/or nanoscale suspension or dispersion. This preferably takes place in an extruder, where mixing of the magnesium hydroxide particles with the polymer, which might already have been melted, can take place.

In a preferred embodiment of the present invention, the suspension or dispersion of the magnesium hydroxide particles additionally contains thermoplastic in solid form, preferably as a granulate, before it is passed to the extruder. Feed of a dispersion or suspension to the mixing device, such as the extruder, in which the magnesium hydroxide particles were mixed with the thermoplastic in advance, for example in the form of the granulate, is particularly preferred if the filled thermoplastic is supposed to have a degree of filling of at least 40 wt.-%, such as at least 50 wt.-%, and particularly at least 60 wt.-%.

Preferably, the coarse-scale and/or nanoscale, coated magnesium hydroxide particles that were used were not subjected to a drying step, in order to minimize or prevent any agglomerate formation.

In contrast to the conventionally used material of magnesium hydroxide particles that are introduced into thermoplastics, which are actually mechanical comminution products and in which the aggregates must be broken up, in the case of the present magnesium hydroxide particles being used, each one of the individual primary particles is already coated, so that de-agglomeration of the agglomerates into primary particles is advantageously possible. This is clearly less energy-consuming and time-consuming than mechanical comminution, as it is required for aggregates of the state of the art. Also, in the case of the precoated material, it is possible to achieve clearly lower particle size distributions by means of bead-mill grinding or ultrasound. Comminuting conventional material by ultrasound requires greater amounts of energy and would therefore be disadvantageous from an economic point of view. When mixing the magnesium hydroxide particles in suspension or dispersion with the melted thermoplastic, the mechanical forces that act during mixing, for example in an extruder or kneader, are sufficient to loosen up the loose agglomerates that might have been formed, and thereby it is possible to obtain thermoplastics in which essentially primary particles of the magnesium hydroxide are present.

In this connection, an essential aspect of the method according to the invention, in accordance with steps b) and c), is that the coarse-scale and/or nanoscale, coated, de-agglomerated magnesium hydroxide particles are used not as a dried powder, in which the particles are present in agglomerated form, but rather as preferably de-agglomerated, coated and, if applicable, functionalized particles, preferably separated primary particles, as a suspension or dispersion.

The magnesium hydroxide used as a starting material demonstrates a low density. Thus, light composite materials can be produced as finished components. Such light construction materials on a polymer basis find use in various areas, for example in aircraft, vehicle, or rail construction. Furthermore, the starting materials for the production of the magnesium hydroxide nanoparticles are cost-advantageous and thus allow the production of cost-advantageous end products. Magnesium hydroxide has the further advantage that nanoparticles of magnesium hydroxide, because of the water of crystallization that is enclosed in them, can give off their water of crystallization particularly rapidly in the case of a fire, because of the large surface, thus cooling of the polymer takes place rapidly, and subsequently a protective oxide layer can form. As a result, the filled thermoplastics according to the invention are particularly suitable also as fire protection agents. Another advantage of the method according to the invention is that coupling of the magnesium hydroxide particles with the thermoplastic is simplified by the use of sterically stabilized additives, particularly functionalized additives. Thus, complete binding of the nanoparticles to the polymer matrix is made possible. Specifically in the case of nanoparticles, for which there is no fear that the polymer will become brittle, when they are introduced in de-agglomerated form, but rather impact viscosity-modifying properties are expected, an improvement in the elongation to fracture and the impact bending resistance as well as an increase in the modulus of elasticity are achieved.

Finally, the economic aspect is of interest. Particularly when using ultrasound, cost-advantageous production of filled thermoplastic polymers and polymer materials on a large scale can be achieved.

As described above, the coarse-scale or nanoscale magnesium hydroxide, which was produced according to the methods described above, and whose primary particles demonstrate a precoating with the growth inhibitor A, the dispersant B and/or the aqueous stearate solution C, can be used as a starting material. Depending on the additive used, the suspension or dispersion that is obtained can be directly subjected to bead-mill grinding or ultrasound treatment, or prior drying of the magnesium hydroxide particles is carried out if the solvent is supposed to be changed. This drying can take place, for example, by means of spray-drying. If the precoated magnesium hydroxide produced in this manner is spray-dried, a loosely agglomerated nanoscale or coarse-scale magnesium hydroxide powder is formed, which is accordingly coated with the growth inhibitor A, the dispersant B and/or the aqueous stearate solution C.

This powder can be de-agglomerated in an aqueous or organic solvent, by means of a bead mill, using suitable sterically stabilized dispersant B or dispersant D. As a result, coarse-scale and/or nanoscale magnesium hydroxide dispersions in either aqueous or organic solvents are obtained (as described, for example, German Patent Application No. 10 2008 031 361.0, which has not yet been published, and which is incorporated herein by reference). These dispersions can then be worked into thermoplastics, according to the invention.

The dispersant B has one or more anionic groups in its molecule. It can be present, for example, in low-molecular, monomer, or oligomer form, or as a polymer. The dispersant B can also be used as a salt of this compound, whereby the main chain, which contains multiple anionic groups, can also be branched or cyclic, with hydrophobic and/or hydrophilic structures. These anionic groups, for example carboxy, phosphonate, phosphate, sulfonate or sulfate groups, bring about anionic coupling of the additive molecule on the filler surface, since these can enter into interactions with the magnesium hydroxide surface. The oligomer or polymer main chains that are additionally present, and, if applicable, the additional side chains, allow further electrostatic and/or steric stabilization, and thereby prevent re-agglomeration. The side chains can consist of semi-polar and/or hydrophilic structures. In addition, they give the particles an external polarity that makes the particle appear more hydrophilic or more hydrophobic, depending on the dispersant B, and allows easier introduction into a polymer matrix later, because of this adaptation of the polarity, and prevents agglomeration in the polymer, so that the magnesium hydroxide particles are present, after having been worked in, in de-agglomerated form and homogeneously distributed in the polymer matrix. Also, these dispersants B for aqueous solvents can contain additional reactive end groups, and therefore be functionalized. These functionalized groups comprise hydroxyl groups, but also double bonds, amine, and thiol groups. Using these functional groups, later covalent linking with the components of the polymer can take place, for example OH groups with a diisocyanate, with the formation of a polyurethane.

The dispersant B demonstrates good solubility in water, since, according to the invention, it is present in the reaction mixture for the production of the magnesium hydroxide particles, or is added to the aqueous suspension or dispersion of the magnesium hydroxide particles in the aqueous solvent.

The amount of the dispersant B can vary. Usually, the dispersant B is present in a concentration of 0.1 to 20 wt.-% with reference to the solid content of Mg(OH)₂.

In the case of organic solvents, the dispersant D is used. The dispersant D can be present in low-molecular, monomer, or oligomer form, or as a polymer. This dispersant D for organic solvents, like the dispersant B, has one or more anionic groups, for example sulfonate, sulfate, phosphonate, phosphate or carboxy groups. They allow the corresponding interaction with the surface of the magnesium hydroxide particles, and make it possible to stabilize the resulting particles electrostatically and/or sterically, and thus to prevent re-agglomeration.

These stabilizing dispersants D can contain main chains and, if applicable, additional oligomer or polymer side chains, which for one thing allow steric stabilization, and for another can carry one or more end groups that are able to interact with the target polymer and, if necessary, to bind with the target polymer covalently. These reactive end groups, also referred to as functionalization, are, for example, double bonds, hydroxy, amine, thiol, isocyanate or epoxy groups.

The dispersant D can be present in either low-molecular, monomer, or oligomer form, or as a polymer. The side chains can consist of hydrophobic and/or hydrophilic structures. The sterically stabilizing dispersant D is used in concentrations of 0.1 to 20 wt.-% with reference to the solid content of Mg(OH)₂.

In an embodiment according to the invention, the coarse-scale and/or nanoscale, coated, de-agglomerated and preferably functionalized magnesium hydroxide particles are present in an aqueous solvent, coated with a dispersant B; in another embodiment, the magnesium hydroxide particles are present in an organic solvent, coated with a dispersant D.

Preferably, surface coating of the magnesium particles is carried out as a function of the thermoplastic. If, for example, the magnesium hydroxide suspension or dispersion is worked into a non-polar polymer, such as polyethylene or polypropylene, for example, then the dispersant B or D is also a non-polar dispersant. Alternatively, the use of an aqueous stearate solution C or another fatty acid solution is possible. The different dispersants can be used in combination with a growth inhibitor A, if necessary. However, since the non-polar fatty acids in aqueous solvents do not possess any sterically stabilizing properties, loosely agglomerated suspensions of coated magnesium hydroxide particles are obtained after in situ precipitation—as described, for example, in German Patent Application No. 10 2008 031 361.0. However, these loose agglomerates can be more easily de-agglomerated by the shear forces of the extruder roller during the extrusion process, for example, or during kneading, so that the primary particles are present in the thermoplastic in almost completely separated form.

The same holds true when using organic solvents in combination with the dispersant D. Here, as well, the dispersant D is selected in accordance with the polarity of the target polymer.

In this connection, in one embodiment, the magnesium hydroxide particles can be used directly from the precipitation reaction, as a suspension or dispersion. Alternatively, further treatment of the magnesium hydroxide particles takes place to improve the particle size distribution, and treatment with ultrasound or bead-mill grinding takes place as a comminution process, to improve the de-agglomerability.

As means that allow coating of the precipitated magnesium hydroxide primary particles in situ, both dispersant B and an aqueous stearate solution C are possible. If necessary, a growth inhibitor A can additionally be present.

This growth inhibitor A is, for example, one that is described in the state of the art, for example, in German Patent Application No. DE 103 57 116 A1. The growth inhibitor contains at least two anionic groups. Preferably, the inhibitor contains at least two of the following groups as anionic groups: a sulfate, a sulfonate, a phosphonate, a carboxy or a phosphate group, and preferably at least two identical ones of these groups. Alternatively, two different anionic groups can also be present (as described in German Patent Application No. DE 10 2008 031 361.0).

These anionic groups allow anionic coupling of the additive with the surface of the magnesium hydroxide particles.

The growth inhibitors A can be present in functionalized form, which means that they can contain one or more reactive end groups, for example hydroxyl groups, which can later interact with a polymer as a functional group, and form covalent bonds, for example. As examples, the covalent bonds that are formed between OH groups and a diisocyanate that is present in the polymer, forming a polyurethane, will be mentioned. Such reactive groups can furthermore be double bonds, hydroxy, amine, and thiol groups.

The stearate solution C is an aqueous stearate solution, for example a sodium stearate solution. The stearate can be added to the one of the stated solutions, the magnesium salt solution or the alkali hydroxide solution, in solid form, and thus be present during precipitation. Because of its carboxyl groups as anionic groups, the stearate surrounds the primary particles of the magnesium hydroxide that form during precipitation, and coats them accordingly. The particles obtained in this manner demonstrate loose agglomerates and an improved de-agglomeration behavior.

The solvent for the magnesium hydroxide particles used according to the invention, in the form of a suspension or dispersion, can be usual aqueous and organic solvents. As organic solvents, the following can be used, for example: ethanol, propanol, butanol, acetone, methylethyl ketone, toluene, ethyl acetate, and boiling point benzene. Furthermore, plasticizers on a phthalate basis are possible organic solvents. Aqueous solvents can be usual aqueous solvents, such as water and water/alcohol mixtures.

The solvents advantageously evaporate when the magnesium hydroxide particles are brought into contact with and/or mixed with the melted thermoplastic. If necessary, the mixture of thermoplastic and magnesium hydroxide particles can be heated further, in order to allow complete evaporation of the solvent, if necessary.

Preferably, the solvent of the suspension or dispersion is removed in at least one degasification zone of the device for carrying out the method, such as an extruder.

The degree of filling with magnesium hydroxide particles in thermoplastics when carrying out the method according to the invention amounts to 0.5 to 80 wt.-% filler content in the polymer. The suspension or dispersion used preferably has a solid content of magnesium hydroxide particles of 0.1 to 70 wt.-%.

The thermoplastics are selected from among the thermoplastic plastics: polypropylenes, polyethylenes, ethyl vinyl acetates, polyvinyl chlorides, polyamides, polyesters, poly(meth)acrylates, polymethyl (meth)acrylates, polycarbonates, acrylnitrile-butadiene-styrenes, polystyrenes, styrene-butadienes, acrylnitrile-styrenes, polybutenes, polyethylene terephthalates, polybutylene terephthalates, modified polyphenyl ethers, aliphatic polyketones, polyaryl sulfones, polyphenylene sulfides.

Preferably, non-polar thermoplastics are involved, such as polypropylene or polyethylene, or polar thermoplastics, such as ethyl vinyl acetate (EVA) and polyamides.

In another aspect, the present invention is directed at a device for the production of thermoplastics containing coarse-scale and/or nanoscale, coated magnesium hydroxide particles, whereby the magnesium hydroxide particles are added to the thermoplastics in the form of a suspension or dispersion. The device has at least one feed device for thermoplastic polymer, one feed device for a suspension or dispersion containing coarse-scale and/or nanoscale, coated, de-agglomerated magnesium hydroxide particles; a first zone in which the thermoplastic is fed in by way of the first feed device, a second zone in which the suspension or dispersion of the magnesium hydroxide particles is fed in by way of the second feed device, if necessary a first degasification zone, if necessary a second degasification zone, a heatable region for melting the thermoplastic, and a device for mixing the melted thermoplastic and the magnesium hydroxide particles.

In one embodiment, the device is an extrusion device, in which the device for mixing the melted thermoplastic and the magnesium hydroxide particles is preferably a heated extruder screw (single or double extruder screw). The feed of the suspension or dispersion of magnesium hydroxide particles preferably takes place using a pump, by way of the feed device.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a device according to the invention for implementing the method according to the invention;

FIG. 2 shows an embodiment of the feed device for a dispersion or suspension containing coarse-scale or nanoscale, coated, de-agglomerated magnesium hydroxide particles;

FIG. 3 shows raster-electron microscope images of a thermoplastic according to the invention with 40 wt.-% nanoscale, coated magnesium hydroxide. A 6700 times enlargement is shown on the left; on the right, a detail of the image on the left, with a 26,800 times enlargement, is shown; and

FIG. 4 shows the values for the modulus of elasticity by means of elongation to tear measurements.

### DETAILED DESCRIPTION OF THE PREFERRED EMBODIMENT

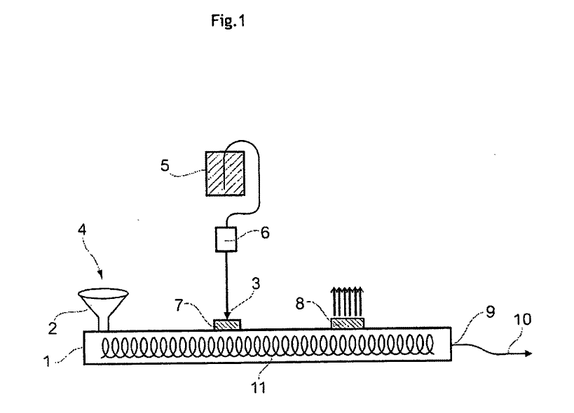

The device will be explained in greater detail, making reference to FIG. 1. The device comprises a first zone of the extruder 1, having a first feed device 2, by way of which the starting materials, the thermoplastic (granulate) 4 are fed, and a second zone having a second feed device 3, by way of which the suspension or dispersion containing coarse-scale and/or nanoscale, coated, de-agglomerated and, if applicable, functionalized magnesium hydroxide particles, are fed. The thermoplastic 4 is fed into a first zone of the extruder 1 by way of first feed device 2. The thermoplastic polymer (thermoplastic) 4 is then transported in the direction of the outlet opening 9, for example a die, using an extruder screw 11. With a second feed device 3, the dispersion containing coarse-scale and/or nanoscale, coated, de-agglomerated, if applicable functionalized magnesium hydroxide particles, is fed to a second zone of the extruder. Preferably, this takes place using a pump 6, for example a spin pump. This pump 6 conveys the suspension or dispersion containing coarse-scale and/or nanoscale, coated, de-agglomerated magnesium hydroxide particles from a supply container/exchangeable container 5 to the feed device 3. The second zone, to which the suspension or dispersion of the magnesium hydroxide particles is passed by way of the feed device, is partly or completely identical in coverage with a first degasification zone 7, if necessary. Particularly if the thermoplastic polymer is present in the melted state when the magnesium particles are introduced, immediate evaporation of the solvent takes place in the degasification zone 7 when the magnesium hydroxide suspension or dispersion is fed in. Using suitable devices, these gaseous solvents can be passed out of the system. The extruder screw 11 can preferably be heated, to allow melting of the thermoplastic. The device has a second degasification zone 8, if necessary, in which gaseous compounds are drawn off, for example water vapor or other ingredients, particularly solvents of the magnesium hydroxide particles. The heatable region of the device can extend over the entire extruder, or, alternatively, the heatable region can lie only after the feed region (“second zone”) for the suspension or dispersion containing coarse-scale and/or nanoscale, coated, de-agglomerated magnesium hydroxide particles. In this case, this requires the presence of a second degasification zone 8, in order to remove evaporating solvents. The device that is furthermore present for mixing melted thermoplastic and magnesium hydroxide particles is preferably the extruder screw 11, which can be present as a single screw or double screw. Alternatively, homogeneous mixing could also take place with other usual means, such as a kneader. Using the screw, the magnesium hydroxide particles are homogeneously distributed in the melted thermoplastic. The screw guides this homogeneous mixture of thermoplastic and magnesium hydroxide particles in the direction of the outlet opening 9. This results in compression of the homogeneous mixture of polymer and magnesium hydroxide particles in a compression zone. Finally, the mixture is extruded in the outlet zone, through the outlet opening 9, usually a die, and the thermoplastic extrudate 10 filled with magnesium hydroxide particles is obtained.

The feed device 3 was selected in such a manner that the cold dispersion/suspension is introduced into the hot carrier material, which has already been melted. The feed of the dispersion/suspension was implemented by means of a specially developed insulator, which applies the cold dispersion/suspension directly to the double screw. The geometry of the double screw was selected in such a manner that the relaxation zone of the screw lies at/close to the location of the feed device 3.

The position of the feed devices 2, 3 (metering zones) must be adapted to the throughput volume and the L/D ratio of the double-screw extruder. The L/D ratio (length/diameter) amounts to between 1/25 and 1/38. An L/D ratio of 1/32 was used.

The device comprises in one embodiment:

1) a cooled intake zone having feed device 2 with application of the granulate or powder 4,

2) a zone for melting and homogenizing the thermoplastic,

3) feed of the suspension/dispersion 3 using a spin pump 6, which introduces this suspension/dispersion into the extruder screw 11 under uniform pressure, by way of a Teflon insulator,

4) a relaxation zone, in which the mixture is completely homogenized and completely melted, and

5) removal of the solvent in a first degasification zone 7, if necessary followed by additional degasification zones 8, for example in the case of a higher solvent content of the suspension/dispersion.

The Teflon insulator is placed after ¼ of the length of the extruder, for example. This thermoplastic can then be processed further according to usual methods. For example, the filled polymer extrudate 10 that is obtained can be granulated using a corresponding device, in order to thereby make available a master batch that is then used for further processing. This further processing can be an injection-molding process, for example, in order to produce the desired products.

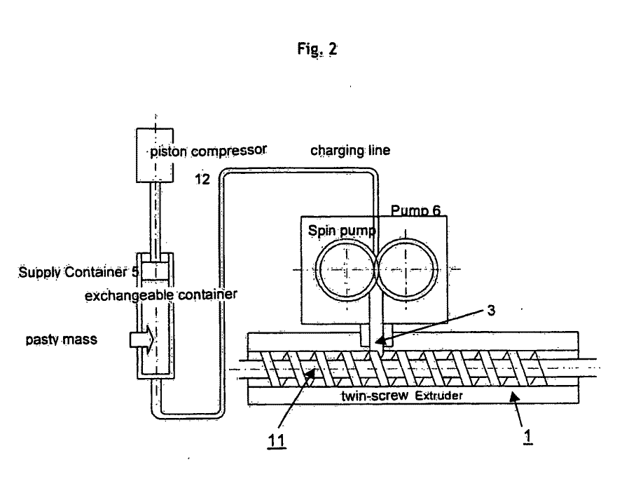

In preferred embodiments, feed of the dispersion takes place using a spin pump having an exchangeable container (FIG. 2). In this exchangeable container, a piston compressor 12 presses the suspension or dispersion out of the supply container/exchangeable container 5 in the direction of the spin pump 6. This is particularly suitable for suspensions or dispersions having a high solids content, for example for suspensions or dispersion having a solids content of up to 60 wt.-%. This pump allows a uniform feed output.

Finally, the present application is directed at thermoplastics that contain coarse-scale and/or nanoscale, coated, de-agglomerated and possibly functionalized magnesium hydroxide particles that can be obtained according to the method according to the invention.

The magnesium hydroxide particles that are used can preferably be obtained according to the in situ method, as described in DE 10 2008 031 361.0.

These thermoplastics have improved mechanical properties, particularly an improved modulus of elasticity (E modulus). Furthermore, the tendency to become brittle can be reduced.

In the following, the invention will be explained in greater detail, making reference to an example, without being restricted to this example.

### EXAMPLES

An extruder device equipped with a spin pump with piston feed, for feeding the suspension or dispersion of magnesium hydroxide particles, was used. A thermoplastic, Escorene UL 00119 (ethylene vinyl acetate, EVA, Exxon) was introduced into the extruder, fed in by way of the first feed device. The extruder is equipped with an extruder screw that can be heated. The extruder screw melts the thermoplastic, which is fed in in the form of powder or granulate. By way of a spin pump with piston feed, the suspension or dispersion of the magnesium hydroxide particles is added to the melted thermoplastic, and mixed into the melted thermoplastic polymer, by way of a second feed device in the second zone, in which the suspension or dispersion of the magnesium hydroxide particles is fed to the extruder by way of the feed device. In the present case, in a first experiment, EVA filled with 50 wt.-% coarse-scale (d50 approximately 10,000 nm) and 50 wt.-% nanoscale (d50 98 nm) Mg(OH)₂ was used.

The ethyl vinyl acetate granulate for the production of the test bodies having a proportion of 50 and 60 wt.-% nanoscale, coated, de-agglomerated magnesium hydroxide took place by means of mixing the pure EVA granulate with EVA granulate filled with nanoscale magnesium hydroxide (master batch). This master batch was then passed to the extruder by way of the feed device.

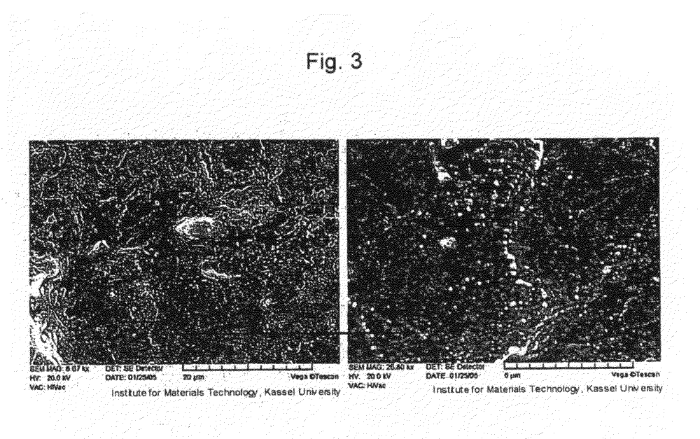

FIG. 3 shows raster-electron-microscope images of the granulate batches obtained. The difference with regard to the particle distribution is clear. Many magnesium hydroxide nanoparticles in the size range around 100 nm can be seen, and only a few agglomerates are evident. In this connection, the nanoparticles are homogeneously distributed in the polymer matrix, and well linked with it.

The filled thermoplastic extrudates that were obtained were granulated according to known methods. Subsequently, sample bodies were produced from these granulate batches, by means of known injection-molding methods. For this purpose, the polymer was melted at 210° C. and injected into a casting mold heated to 60° C. at a speed of 210 mm/min. As compared with the pure EVA, in the production of test rods consisting of 50 wt.-% EVA and 50 wt.-% coarse-scale magnesium hydroxide particles, higher pressures were required for injection. In the case of the nanoscale material, it was easier to draw in the material, as compared with the coarse-scale material. However, even higher pressures were necessary here.

For the production of the sample bodies consisting of 40 wt.-% EVA filled with 60 wt.-% nanoscale, coated, de-agglomerated magnesium hydroxide, the temperature of the intake zone was lowered to 50° C. In the production of these sample bodies, clearly faster cooling was observed. In total, it was possible to determine that the EVA test rods filled with nanoscale, coated, de-agglomerated magnesium hydroxide particles were significantly easier to produce in comparison with test rods that were produced using coarse-scale magnesium hydroxide, because of their better flowability. Also, significantly faster cooling of the test bodies with the nanoscale, coated, de-agglomerated magnesium hydroxide was observed, in comparison with test bodies containing coarse-scale magnesium hydroxide or unfilled test bodies.

### Mechanical Characterization

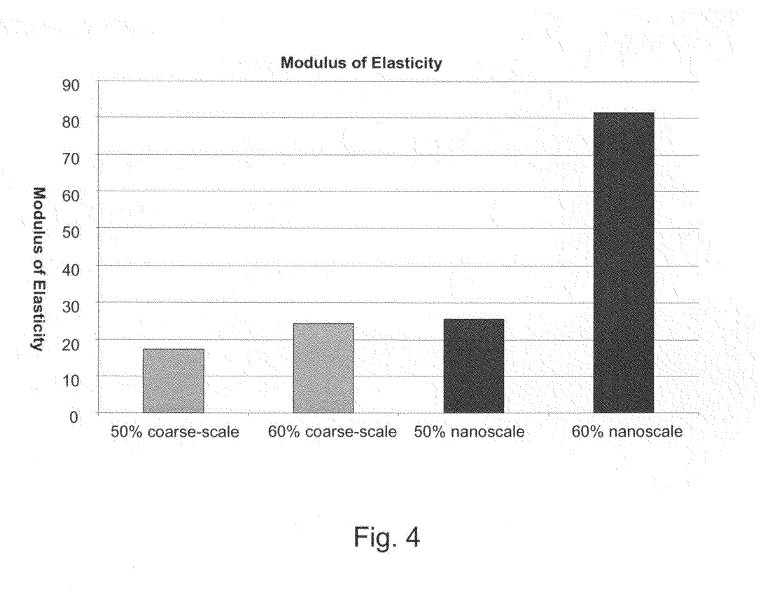

For the mechanical characterization of the sample bodies, elongation to tear measurements (FIG. 4) were carried out. In these tests, the dependence of the particle size on the fracture mechanics was investigated, since experience has shown that nanoparticles, in comparison with coarse filler, demonstrate different fracture mechanics in polymers.

The tensile tests were carried out analogous to DIN EN ISO 527. Before the tests were carried out, the test bodies were stored in a standard climate for 16 hours. Dimensions of the test bodies: standard shoulder rods 2 (DIN EN ISO 527-3 Type 1 to 3); Test velocity: 50 mm/min.

The results of the modulus of elasticity were particularly noteworthy in the tensile tests that were carried out. For this modulus, it was shown that starting from a filler content of 60 wt.-% nanoscale, coated, de-agglomerated magnesium hydroxide, reproducible quadrupling of the modulus of elasticity—in comparison with coarse-scale magnesium hydroxide also with a filler content of 60 wt.-%—occurs. This significant increase in the modulus of elasticity, from 243 N/mm² to 816 N/mm², appears to be attributable to the greatly increased filler surface area, which demonstrates a good interaction with the polymer matrix, according to intensive observation of the raster-electron-microscope image. Because of the increased surface contact of the nanoscale filler with the polymer, a strong reinforcement effect occurs, caused by the filler. At a filler content of 50%, a slight increase in the modulus of elasticity, from 172 N/mm² to 256 N/mm², was recorded.

FIG. 4 shows the results obtained when determining the modulus of elasticity analogous to DIN EN ISO 527 for thermoplastic polymers with 50 and 60% filler content, respectively, of coarse-scale and nanoscale magnesium hydroxide particles, respectively.

Accordingly, while only a few embodiments of the present invention have been shown and described, it is obvious that many changes and modifications may be made thereunto without departing from the spirit and scope of the invention.

### LIST OF REFERENCE NUMBERS

1 extruder
2 first feed device
3 second feed device
4 powder or granulate of the thermoplastic
5 supply container/exchangeable container
6 spin pump
7 first degasification zone
8 second degasification zone
9 outflow opening
10 filled thermoplastic extrudate
11 extruder screw
12 piston compressor

What is claimed is:

1. A method for the production of filled thermoplastics containing coarse-scale and/or nanoscale, coated and de-agglomerated magnesium hydroxide particles in the form of the coated primary particles, comprising the steps of:
a) providing a thermoplastic in a heated, melted form;
b) providing coarse-scale and/or nanoscale, coated magnesium hydroxide particles as a suspension or dispersion in an aqueous or organic solvent;
c) feeding the magnesium hydroxide particles into the thermoplastic;
d) mixing the magnesium hydroxide particles with the heated, melted thermoplastic; and
e) removing the solvent of the suspension or dispersion from the mixture of step (d).

2. The method according to claim 1, further comprising the step of extruding the thermoplastic containing the magnesium hydroxide particles after said step of removing the solvent.

3. The method according to claim 1, wherein the magnesium hydroxide particles are present in de-agglomerated form.

4. The method according to claim 1, wherein the magnesium hydroxide particles are provided in an organic solvent and are coated with a dispersant.

5. The method according to claim 1, wherein the magnesium hydroxide particles are provided in an aqueous solvent, and coated with a dispersant.

6. The method according to claim 1, wherein the step of providing the magnesium hydroxide particles comprises treating precoated magnesium hydroxide particles with ultrasound, in the presence of a dispersant in an aqueous solvent, or in the presence of a dispersant in an organic solvent.

7. The method according to claim 1, wherein the step of providing the magnesium hydroxide particles comprises bead-mill grinding of a suspension or dispersion of uncoated or precoated magnesium hydroxide particles in an aqueous solvent in the presence of a dispersant, or in an organic solvent in the presence of a dispersant.

8. The method according to claim 1, wherein the magnesium hydroxide particles are provided in an aqueous solvent, and are coated with a stearate.

9. The method according to claim 1, wherein the magnesium hydroxide particles are provided with a coating of a growth inhibitor.

10. The method according to claim 1, wherein the amount of magnesium hydroxide particles in the filled thermoplastic amounts to between 0.5 and 80 wt.-% of the filled thermoplastic.

11. The method according to claim 1, wherein the suspension or dispersion that is fed into the thermoplastic contains 0.1 to 70 wt.-% solids content of magnesium hydroxide particles.

12. The method according to claim 1, wherein the thermoplastic is selected from the group consisting of thermoplastic plastics, polypropylenes, polyethylenes, ethyl vinyl acetates, polyvinyl chlorides, polyamides, polyesters, poly(meth)acrylates, polymethyl(meth)acrylates, polycarbonates, acrylnitrile-butadiene-styrenes, polystyrenes, styrene-butadienes, acrylnitrile-styrenes, polybutenes, polyethylene terephthalates, polybutylene terephthalates, modified polyphenyl ethers, aliphatic polyketones, polyaryl sulfones, and polyphenylene sulfides.

13. The method according to claim 1, wherein the magnesium hydroxide particles are functionalized.

14. A device for the production of filled thermoplastics containing coarse-scale and/or nanoscale, coated magnesium hydroxide particles substantially in the form of the coated primary particles, wherein the magnesium hydroxide particles are added to the thermoplastic in the form of a suspension or dispersion, the device comprising:
a first feed device for a thermoplastic polymer;
a second feed device for the magnesium hydroxide particles;
a first zone in which the thermoplastic is fed in by way of the first feed device;
a second zone in which the dispersion or suspension of the magnesium hydroxide particles is fed in by way of the second feed device;
a first degasification zone;
a second degasification zone;
a heatable region for melting the thermoplastic; and
a device for mixing melted thermoplastic and magnesium hydroxide particles.

15. The device according to claim 14, further comprising a pump for feeding the dispersion or suspension of magnesium hydroxide particles by way of the second feed device.

16. The device according to claim 14, wherein the device is an extrusion device.

17. The device according to claim 16, wherein the device for mixing the melted thermoplastic and the magnesium hydroxide particles is a heatable extruder screw.

18. A filled thermoplastic containing coarse-scale or nanoscale, coated, de-agglomerated magnesium hydroxide particles.
